(19) United States
(12) Patent Application Publication
(10) Pub. No.: US 2024/0391242 A1
(43) Pub. Date: Nov. 28, 2024

(54) LIQUID CONTAINER AND LIQUID EJECTION APPARATUS

(71) Applicant: SEIKO EPSON CORPORATION, Tokyo (JP)

(72) Inventors: Takeru OGUCHI, CHINO-SHI (JP); Koki MURAKAMI, AGEMATSU-MACHI (JP); Hiroshi SHIOBARA, MATSUMOTO-SHI (JP); Tatsuya HOSOKAWA, MATSUMOTO-SHI (JP); Shintaro KOMURO, MATSUMOTO-SHI (JP); Kazuhiro KOBAYASHI, SHIOJIRI-SHI (JP); Yutaro KAJITANI, MATSUMOTO-SHI (JP); Chiaki SHIMADA, OKAYA-SHI (JP)

(21) Appl. No.: 18/672,677

(22) Filed: May 23, 2024

(30) Foreign Application Priority Data
May 26, 2023 (JP) 2023-086767

(51) Int. Cl. B41J 2/175; B41J 29/46

(52) U.S. Cl. CPC B41J 2/17526; B41J 2/1752; B41J 2/17553; B41J 29/46

(57) ABSTRACT

A liquid container is a liquid container configured to contain ink to be ejected onto a medium by a liquid ejection apparatus, the liquid container including a containing unit configured to contain the ink, a containing unit which is disposed not to communicate with the containing unit, and which is configured to contain same ink as the ink contained in the containing unit, and a coupling portion configured to couple the containing units to each other, wherein the containing units include derivation units configured to derive the ink contained in the containing units, and the containing units are individually sealed.

The present application is based on, and claims priority from JP Application Serial Number 2023-086767, filed May 26, 2023, the disclosure of which is hereby incorporated by reference herein in its entirety.

### BACKGROUND

### 1. Technical Field

The present disclosure relates to a liquid container and a liquid ejection apparatus.

### 2. Related Art

JP-A-2017-64917 discloses a printing apparatus that includes a used amount prediction unit, a recommended quantity item selection unit, and a notification unit and performs printing using a consumable item. The used amount prediction unit predicts the used amount by the user during the guaranteed period of the consumable item based on a period of use and a used amount of the consumable item. The recommended quantity a item selection unit selects consumable item having a recommended quantity that can be consumed by the user within a guaranteed period from a group of consumable items different in quantity based on the predicted used amount by the user. In addition, it is disclosed that the printing apparatus notifies the user of the consumable item having the recommended quantity that can be consumed by the user within the guaranteed period with the notification unit.

JP-A-2017-64917 is an example of the related art.

However, in the printing apparatus disclosed in JP-A-2017-64917, the consumable item having the recommended quantity that can be consumed by the user within the guaranteed period is selected based on the used amount of the consumable item in a certain past period. For this reason, there is a concern that usability may be reduced when the used amount of the consumable item per predetermined period is changed.

### SUMMARY

A liquid container is a liquid container configured to contain a liquid to be ejected onto a medium by a liquid ejection apparatus, and includes a first containing unit configured to contain the liquid, a second containing unit which is disposed not to communicate with the first containing unit, and which is configured to contain a same liquid as the liquid contained in the first containing unit, and a coupling portion configured to couple the first containing unit and the second containing unit to each other, wherein the first containing unit is provided with a first derivation unit configured to derive the liquid contained in the first containing unit, the second containing unit is provided with a second derivation unit configured to derive the liquid contained in the second containing unit, and the first containing unit and the second containing unit are individually sealed.

A liquid ejection apparatus includes a loading unit configured to detachably load the liquid container, a coupling terminal provided to the loading unit, and a control unit, wherein the liquid container is configured to be loaded on the loading unit in a first posture in which the liquid is derived from the first derivation unit to the liquid ejection apparatus and a second posture which is different from the first posture and in which the liquid is derived from the second derivation unit to the liquid ejection apparatus, the liquid container includes a first contact point configured to electrically be coupled to the coupling terminal when the liquid container is loaded on the loading unit in the first posture, and a second contact point configured to electrically be coupled to the coupling terminal when the liquid container is loaded on the loading unit in the second posture, and the control unit determines expiration of an expiration date of the liquid contained in the first containing unit when an elapsed time from when the first contact point and the coupling terminal are electrically coupled to each other reached a first predetermined time, and determines expiration of the expiration date of the liquid contained in the second containing unit when an elapsed time from when the second contact point and the coupling terminal are electrically coupled to each other reached a second predetermined time.

A liquid ejection apparatus includes the loading unit configured to detachably load the liquid container, a first introduction unit configured to introduce the liquid from the first derivation unit in a state where the liquid container is loaded on the loading unit in a first posture, and a second introduction unit configured to introduce the liquid from the second derivation unit in a state where the liquid container is loaded on the loading unit in the first posture.

### BRIEF DESCRIPTION OF THE DRAWINGS

FIG. 1 is a schematic top view showing an embodiment of a liquid ejection apparatus.

FIG. 2 is a schematic cross-sectional view showing a liquid container loaded on a loading unit of the liquid ejection apparatus.

FIG. 3 is a schematic cross-sectional view showing a liquid container loaded on a loading unit of the liquid ejection apparatus.

FIG. 4 is a schematic cross-sectional view showing a liquid container loaded on a loading unit of the liquid ejection apparatus.

FIG. 5 is a schematic cross-sectional view showing the liquid container loaded on the loading unit of the liquid ejection apparatus.

FIG. 6 is a flowchart representing a flow of container information processing.

FIG. 7 is a flowchart representing a flow of remaining amount confirmation processing.

FIG. 8 is a schematic cross-sectional view showing the liquid container loaded on the loading unit of the liquid ejection apparatus.

FIG. 9 is a schematic cross-sectional view showing the liquid container loaded on the loading unit of the liquid ejection apparatus.

FIG. 10 is a perspective view showing the liquid container that can be loaded on the loading unit of the liquid ejection apparatus.

FIG. 11 is a schematic front view showing the liquid ejection apparatus to which the liquid container shown in FIG. 10 is attached.

FIG. 12 is a schematic cross-sectional view showing another embodiment of the liquid ejection apparatus to which the liquid container is attached.

FIG. 13 is a schematic cross-sectional view showing another embodiment of the liquid ejection apparatus.

### DESCRIPTION OF EMBODIMENTS

Hereinafter, the present disclosure will be described based on some embodiments. In the drawings, the same reference numerals are given to the same members, and redundant descriptions will be omitted. Note that in the present specification, terms “the same”, “identical”, and “the same time” not only mean completely the same, but also include when things are the same in consideration of a measurement error, when things are the same in consideration of a production tolerance of the things, and when things are the same as long as functions are not impaired. Therefore, for example, “dimensions of things are the same” means that a dimensional difference between the things is within ±10%, more preferably within ±5%, and particularly preferably within ±3% of the dimension of one of the things in consideration of a measurement error and a production tolerance of them.

Further, in the drawings, X, Y, and Z represent three spatial axes perpendicular to each other. In the present specification, the directions along these axes are referred to as an X-axis direction, a Y-axis direction, and a Z-axis direction. The directions are specified by defining a positive direction as “+”, and a negative direction as “−” as needed in the description. In that case, the positive sign and the negative sign are used in combination with the direction notations to define the directions in which the arrows in the drawings are directed as + directions, and opposite directions to the arrows as − directions.

Further, the Z-axis direction represents a gravitational direction, the +Z direction represents a vertically upward direction, and the −Z direction represents a vertically downward direction. Further, in the description, a plane including the X axis and the Y axis is referred to as an X-Y plane, a plane including the X axis and the Z axis is referred to as an X-Z plane, and a plane including the Y axis and the Z axis is referred to as a Y-Z plane. Further, the X-Y plane is a horizontal plane. Further, the three spatial axes X, Y, and Z which are not limited to the positive direction or the negative direction will be described as the X axis, the Y axis, and the Z axis.

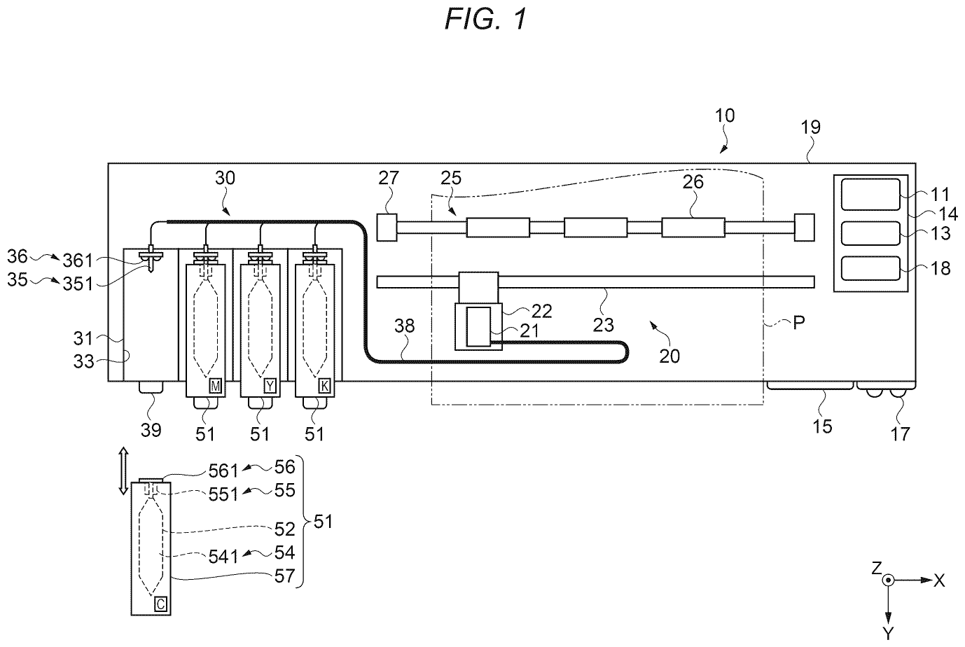

Note that in the drawings, the X-axis direction is a width direction of a chassis 19 in a liquid ejection apparatus 10 described later, and is also a width direction of a medium P crossing a conveyance direction in which the medium P is conveyed. In the X-axis direction, the +X direction is a right direction as viewed from a user when the front surface of the chassis 19 faces the user, and the −X direction is a left direction in that case. In the present embodiment, a side surface (see FIG. 1) to which a liquid container 51 is attached and detached among side surfaces constituting the periphery of the chassis 19 is a front surface of the chassis 19. The Y-axis direction is a depth direction of the chassis 19. The +Y direction of the Y-axis direction is a direction from a back surface of the chassis 19 toward the front surface of the chassis 19. In addition, the −Y direction in the Y-axis direction is a direction from the front surface of the chassis 19 toward the back surface of the chassis 19.

### 1. Embodiment 1

The liquid ejection apparatus 10 is, for example, an inkjet printer that records images such as characters and photographs by ejecting ink, which is an example of a liquid, onto a medium P such as paper or cloth.

As shown in FIG. 1, the liquid ejection apparatus 10 includes a control unit 11, a storage unit 13, a display unit 15, an operation unit 17, a communication unit 18, an ejection unit 20, and a liquid supply unit 30 in the chassis 19.

The control unit 11 controls operations of the liquid ejection apparatus 10. The control unit 11 is formed of a computer including at least one processor and a main storage device. The control unit 11 exerts various functions for controlling the liquid ejection apparatus 10 by the processor reading programs and commands into the main storage device and then executing the programs and the commands. Note that at least some of the functions of the control unit 11 may be realized by a hardware circuit on a circuit board 14.

Under the control of the control unit 11, the storage unit 13 stores, in a nonvolatile manner, various types of control information used by the control unit 11 to control the liquid ejection apparatus 10. The control information stored in the storage unit 13 includes, for example, container individual information which is individual information of each of the liquid containers 51 loaded on respective loading units 31 of the liquid supply unit 30 described later. The container individual information will be described later.

Under the control of the control unit 11, the display unit 15 announces a message to the user, status information representing the current state of the liquid ejection apparatus 10, and so on. The display unit 15 is formed of, for example, a liquid crystal panel. The annunciation content by the display unit 15 will be described later.

The operation unit 17 receives an operation from the user, and outputs the operation content to the control unit 11. The operation unit 17 includes, for example, buttons and switches disposed on a front surface of the liquid ejection apparatus 10. The operation unit 17 may include an operation device such as a keyboard of a computer coupled to the liquid ejection apparatus 10. Further, a touch panel or the like may also serve as both of the display unit 15 and the operation unit 17.

The communication unit 18 couples the control unit 11 and an external device to each other. The communication unit 18 includes a communication interface, one of a communication cable and a wireless communication line, and so on provided to the liquid ejection apparatus 10. Examples of the external device include a personal computer, a smartphone, a mobile phone, and a portable information terminal.

In the liquid ejection apparatus 10, the ink supplied by the liquid supply unit 30 is consumed by print processing executed by the ejection unit 20. The ejection unit 20 includes a head 21, a carriage 22 on which the head 21 is mounted, and a conveyance unit 25. The head 21 includes a plurality of nozzles, and ejects ink from the nozzles under the control of the control unit 11. Although illustration and detailed description are omitted, in the head 21, the plurality of nozzles forms nozzle arrays for respective colors of ink described later. In the head 21, the ink is ejected from the nozzles by, for example, applying pressure to the ink by a piezoelectric element.

The carriage 22 is attached to a drive shaft 23 extending in the X-axis direction crossing the conveyance direction of the medium P above a conveyance path of the medium P. Under the control of the control unit 11, the carriage 22 reciprocates in the X-axis direction along the drive shaft 23 due to drive force of a motor transmitted via a pulley and an endless belt not shown.

The conveyance unit 25 includes a drive roller 26 that rotates by the drive force of a conveyance motor 27, and rotates the drive roller 26 to convey the medium P under the control of the control unit 11. In the print processing, the control unit 11 moves the carriage 22 according to the print data while making the conveyance unit 25 convey the medium P. The control unit 11 ejects the ink from the head 21 loaded on the carriage 22 which is moving toward the medium P to thereby form an image on the medium P.

The liquid supply unit 30 supplies the ejection unit 20 with the ink contained in the plurality of liquid containers 51 that are attached to the liquid supply unit 30 in a replaceable manner. First, a configuration of the liquid containers 51 attached to the liquid supply unit 30 will be described. The liquid containers 51 each contain the ink to be ejected onto the medium P by the ejection unit 20 of the liquid ejection apparatus 10. In the present embodiment, the liquid containers 51 are each configured as a so-called cartridge.

The liquid containers 51 are loaded on the loading units 31 described later of the liquid supply unit 30 for the respective colors of ink. FIG. 1 shows an example of a configuration in which the liquid containers 51 are loaded for the four colors of ink, namely cyan (C) ink, magenta (M) ink, yellow (Y) ink, and black (K) ink, respectively. In FIG. 1, the alphabets C, M, Y, and K attached to the liquid containers 51 represent types of the colors described above.

Note that the types of the colored ink are not limited to the four colors of C, M, Y, and K. The liquid containers 51 may contain, for example, light cyan ink, light magenta ink, or other special colors of ink in addition to the coloreds of ink described above or instead of any of the colors of ink described above. Further, the number of the types of colored ink may be less than four, and for example, only black ink may be used.

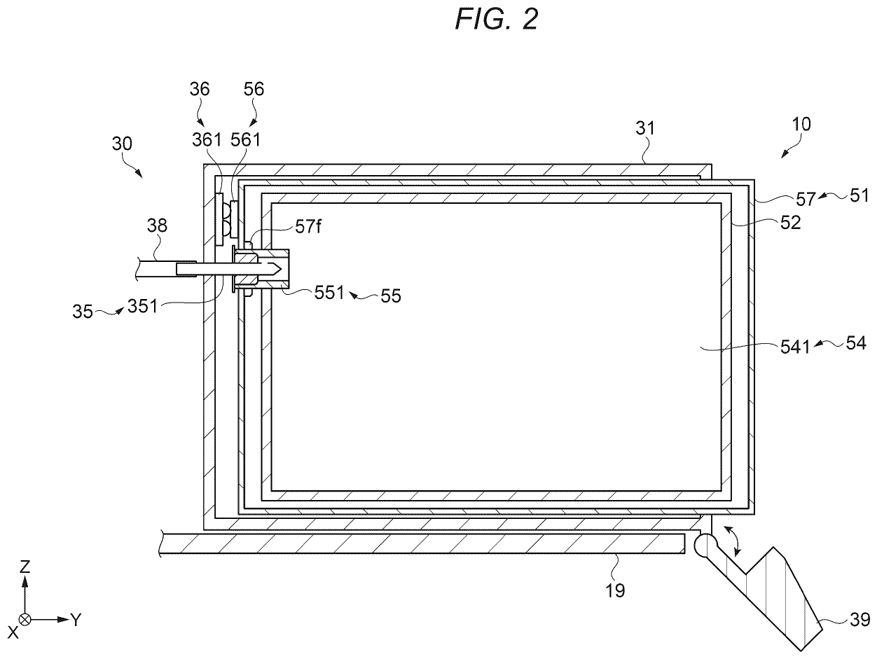

As shown in FIGS. 1 and 2, each of the liquid containers 51 includes a bag body 52, a derivation unit 55, a substrate unit 56, and a housing 57. The bag body 52 forms a containing unit 54 in which the ink is contained. A derivation unit 551 as the derivation unit 55 is attached to the bag body 52 so that the ink in a containing unit 541 as the containing unit 54 can flow out to the outside. The housing 57 houses the bag body 52. The housing 57 has a quadrangular prism shape having six side walls.

The bag body 52 is formed by thermally welding edges of two flexible resin films. As the resin film, for example, a multilayer film obtained by sandwiching an aluminum foil between a a polypropylene film and polyethylene film is adopted. Accordingly, in a state where the derivation unit 55 is hermetically sealed, deterioration in quality of the ink contained in the containing unit 54 is prevented. When the sealed state of the derivation unit 55 is released, the deterioration in quality of the ink due to evaporation of a solvent from the ink, entry of air into the containing unit 54, and the like progresses over time.

In a loading direction in which the liquid container 51 is attached and detached indicated by the unfilled arrow in FIG. 1, a fixing portion 57f (see FIG. 2) is disposed on an inner side surface of a side wall that forms a back side in the loading direction out of side walls of the housing 57. By fixing the derivation unit 551 to the fixing portion 57f, a tip of the derivation unit 551 protrudes from the outer side surface of the side wall. As shown in FIG. 2, the derivation unit 551 is disposed at a position at the +Z direction side from the center of the liquid container 51 in the Z-axis direction. Accordingly, when the liquid container 51 is loaded on the loading unit 31 of the liquid supply unit 30 described later, the derivation unit 551 is coupled to an introduction unit 351 as an introduction unit 35 of the liquid supply unit 30 described later.

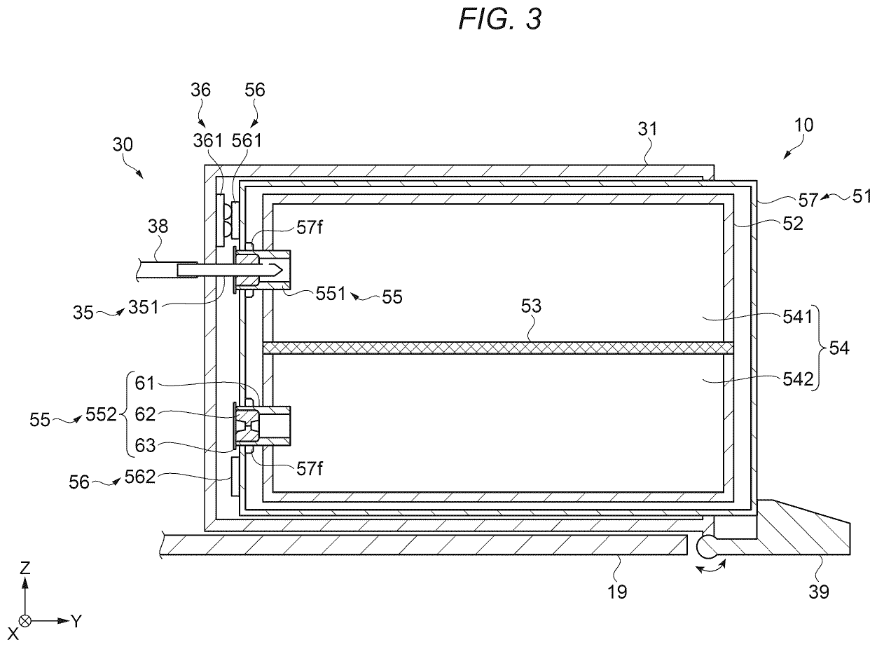

Similarly to a derivation unit 552 (see FIG. 3), the derivation unit 551 as the derivation unit 55 shown in FIGS. 1 and 2 includes a derivation pipe 61, a valve body 62, and a sealing body 63. The derivation pipe 61 houses the valve body 62. The valve body 62 is, for example, a seal rubber that can take a closed valve state in which discharge of the ink from the derivation unit 55 is restricted and an open valve state in which the discharge of the ink from the derivation unit 55 is allowed due to an entrance of the introduction unit 35. The sealing body 63 covers an opening of the tip at the −Y direction side of the derivation pipe 61 to thereby seal the inside of the derivation unit 55 and the inside of the containing unit 54 from which the derivation unit 55 can derive the ink.

For example, the sealing body 63 attached to the tip of the derivation pipe 61 of the derivation unit 551 seals the inside of the derivation unit 551 and the inside of the containing unit 541 from which the derivation unit 551 can derive the ink. The sealing body 63 of the present embodiment is a resin film shaped like a thin film which is thermally welded to the tip of the derivation pipe 61. Therefore, when the derivation unit 55 is coupled to the introduction unit 35, a through hole is provided to the sealing body 63 due to the entrance of the introduction unit 35 into the derivation unit 55. Thus, the sealed state in the derivation unit 55 and the containing unit 54 with the sealing body 63 is released.

As long as the opening at the tip at the −Y direction side of the derivation pipe 61 can be covered, the sealing body 63 may be a resin film that can be peeled off by the user before the liquid container 51 is loaded on the loading unit 31. Alternatively, the sealing body 63 may be a cap that can be detached from the tip of the derivation pipe 61 before the liquid container 51 is loaded on the loading unit 31. According to these, by visually checking the state of the sealing body 63 of the derivation unit 55, it is possible for the user to know whether there is a history that the derivation unit 55 was coupled to the introduction unit 35.

Further, a substrate unit 561 as the substrate unit 56 is attached to an outer side surface of the side wall that forms the back side in the loading direction out of the side walls of the housing 57. The substrate unit 561 is disposed at a position at the +Z direction side of the derivation unit 551 in the Z-axis direction. Accordingly, when the liquid container 51 is loaded on the loading unit 31 and the derivation unit 551 is coupled to the introduction unit 351, the substrate unit 561 is electrically coupled to a coupling terminal 361 as a coupling terminal 36 of the liquid ejection apparatus 10 described later. The substrate unit 56 includes a container side storage unit (not shown) into which information can be written, and which is capable of achieving nonvolatile storage. The container side storage unit stores container information that is information related to the liquid container 51. The container information will be described later.

The liquid supply unit 30 includes the loading units 31 on which the liquid containers 51 are detachably loaded. The loading units 31 have loading slots 33 (see FIG. 1) on which the respective liquid containers 51 are loaded. The loading slots 33 open on the front surface of the chassis 19. The introduction unit 35 to be coupled to the derivation unit 55 of the liquid container 51 is provided on the surface of the loading unit 31 forming the back side in the loading direction in which the liquid container 51 is attached and detached.

Further, the loading unit 31 is provided with the coupling terminal 36 that is electrically coupled to the substrate unit 56 of the liquid container 51 when the liquid container 51 is loaded. The coupling terminal 36 is electrically coupled to the control unit 11, and mediates communication between the substrate unit 56 and the control unit 11. When the control unit 11 detects the electrical coupling between the coupling terminal 36 and a contact point 56c (not shown) provided to the substrate unit 56 of the liquid container 51, the control unit 11 detects the loading of the liquid container 51 on the loading unit 31.

Further, the loading unit 31 is provided with a lever 39 rotatable in directions indicated by black arrows in FIG. 2. As shown in FIG. 3, the lever 39 engages with a part of the liquid container 51 loaded on the loading unit 31 to prevent the liquid container 51 from falling off from the loading unit 31. The lever 39 is capable of locking the liquid container 51 in a state where the substrate unit 56 and the coupling terminal 36 are coupled to each other, and the derivation unit 55 and the introduction unit 35 are coupled to each other.

For example, as shown in FIG. 2, the user can release the engagement of the lever 39 with the liquid container 51 by rotating the lever 39 in a direction away from the liquid container 51. Then, the user can detach the liquid container 51 from the loading unit 31.

The liquid supply unit 30 further includes pipes 38 that respectively couple the introduction units 35 and the heads 21 mounted on the carriage 22 to each other, and through which ink flows. The pipes 38 are each made of, for example, a flexible resin tube.

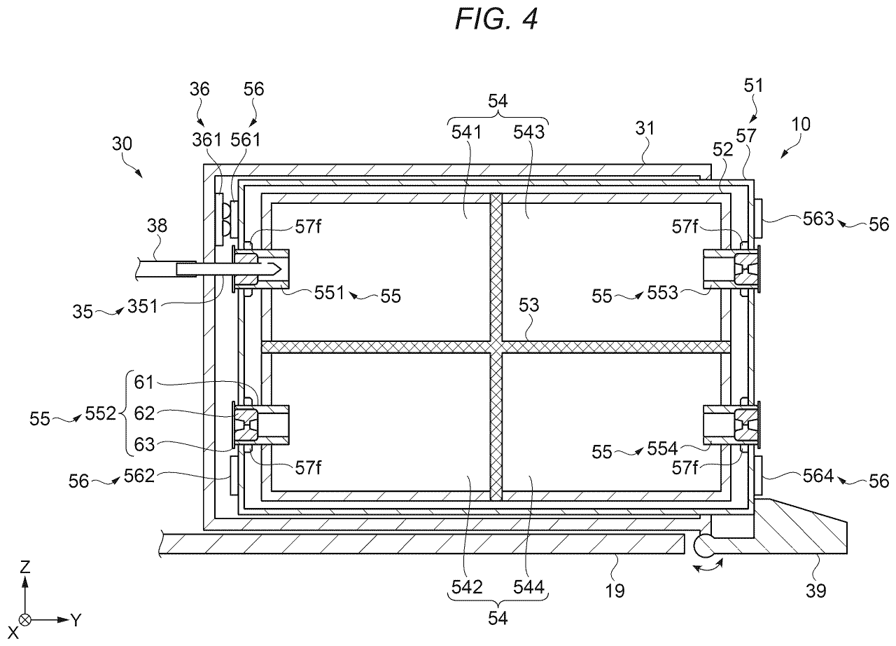

Then, the specifications of the liquid container 51 that can be loaded on the loading unit 31 of the liquid supply unit 30 in the present embodiment will be described. In the present embodiment, in addition to the liquid container 51 including a single containing unit 541 as the containing unit 54, the liquid container 51 (see FIG. 3) including two containing units 541 and 542 as the containing unit 54 can be loaded on the loading unit 31. Further, in the present embodiment, the liquid container 51 (see FIG. 4) including the four containing units 541, 542, 543, and 544 as the containing unit 54 can be loaded on the loading unit 31.

Hereinafter, the liquid container 51 including a single containing unit 541 as the containing unit 54 may be referred to as a liquid container LC1. Further, the liquid container 51 including two containing units 541 and 542 as the containing unit 54 may be referred to as a liquid container LC2. Further, the liquid container 51 including four containing units 541, 542, 543, and 544 as the containing unit 54 may be referred to as a liquid container LC4. Further, the containing unit 541 is an example of a first containing unit, and the containing unit 542 is an example of a second containing unit. Further, the containing unit 543 is an example of a third containing unit, and the containing unit 544 is an example of a fourth containing unit.

First, the liquid container LC2 will be described. As shown in FIG. 3, the liquid container LC2 includes a divider 53 that divides the containing unit 541 of the liquid container LC1 into two. The divider 53 is disposed at the center in the Z-axis direction of the containing unit 54 of the liquid container LC1. The divider 53 is formed by thermally welding the centers of the two resin films that form the containing unit 541 of the liquid container LC1 with a predetermined width over the entire length in the Y-axis direction.

Thus, the containing unit 541 of the liquid container LC1 is divided into two in the Z-axis direction to thereby form the containing units 541 and 542 of the liquid container LC2. Further, the same ink is contained in the containing unit 541 and the containing unit 542. Note that the containing unit 541 and the containing unit 542 in the liquid container LC2 are disposed so as not to communicate with each other. Therefore, the ink contained in the liquid container LC2 does not flow between the containing unit 541 and the containing unit 542.

Furthermore, the liquid container LC2 is provided with a derivation unit 552 as the derivation unit 55 in addition to the derivation unit 551 similar to that of the liquid container LC1. The derivation unit 552 is attached to the bag body 52 so that the ink contained in the containing unit 542 can flow out to the outside. Further, in the liquid container LC2, another fixing portion 57f is disposed on the inner side surface of the side wall forming the back side in the loading direction out of the side walls of the housing 57 in the loading direction in which the liquid container 51 is attached and detached. By fixing the derivation unit 552 to the fixing portion 57f as another fixing portion, the tip of the derivation unit 552 protrudes from the outer side surface of the side wall.

Further, by attaching the sealing body 63 to the tip of the derivation pipe 61 of the derivation unit 552, the inside of the derivation unit 552 and the inside of the containing unit 542 from which the derivation unit 552 can derive the ink are sealed. In other words, the containing unit 541 and the containing unit 542 are individually sealed.

Note that in the present embodiment, the amount of the ink contained in each of the containing units 541 and 542 of the liquid container LC2 is half the amount of the ink contained in the containing unit 541 of the liquid container LC1. Further, the sum of the amounts of the ink contained in the containing units 541 and 542 of the liquid container LC2 is the same as the amount of the ink contained in the containing unit 541 of the liquid container LC1.

The expiration date of the ink contained in the containing unit 541 is counted from the timing when the sealed state of the containing unit 541 is released. Further, the expiration date of the ink contained in the containing unit 542 is counted from the timing when the sealed state of the containing unit 542 is released. Accordingly, compared to the liquid container LC1 that holds the total amount of the ink contained in the containing units 541 and 542 of the liquid container LC2 in the single containing unit 541, the liquid container LC2 can reduce the amount of the ink that needs to be used within the expiration date of the ink to half.

Thus, in the liquid container LC2, the amount of the ink that can be used with one liquid container 51 deals with when the amount of the ink used per predetermined period is large, and at the same time, the amount of the ink that needs to be used within the expiration date of the ink can deal with when the amount of the ink used per predetermined period is small. As a result, the liquid container LC2 can prevent a degradation of usability compared to the liquid container LC1 including the single containing unit 541 even when the amount of the ink used per predetermined period varies. Further, since it is possible to deal with users who are different in amount of the ink used without preparing the liquid containers 51 of various specifications different in amount of the ink contained, it becomes possible to reduce the cost of the liquid containers 51.

The derivation unit 552 is disposed at a position at the −Z direction side of the center of the liquid container LC2 in the Z-axis direction. The derivation unit 552 is disposed at a position at the −Z direction side of the derivation unit 551 in the liquid container LC2. In this case, the derivation direction of the ink from the derivation unit 552 is the −Y direction which is the same as the derivation direction of the ink from the derivation unit 551. Further, the derivation unit 551 and the derivation unit 552 are located at the same position in the Y-axis direction along the derivation direction.

Further, in this case, the derivation unit 551 and the derivation unit 552 are fixed to the respective fixing portions 57f of the housing 57, so that the containing unit 541 and the containing unit 542 are in a coupled state in the liquid container LC2. In other words, the housing 57 is an example of a coupling portion CP that couples the containing unit 541 and the containing unit 542 to each other. Further, the divider 53 may be regarded as an example of the coupling portion CP that couples the containing unit 541 and the containing unit 542 to each other.

For example, when the liquid container 51 as the liquid container LC2 is loaded on the loading unit 31, the posture in which the derivation unit 551 is coupled to the introduction unit 351 of the liquid supply unit 30 is defined as a first posture of the liquid container 51. That is, the posture shown in FIG. 3 is defined as the first posture. Further, a posture obtained by reversing the +Z direction side and the −Z direction side of the liquid container 51 in the first posture to flip the liquid container 51 is defined as a second posture of the liquid container 51. In this case, the derivation unit 552 is disposed at a position where the derivation unit 552 is coupled to the introduction unit 351 of the liquid supply unit 30 when the liquid container LC2 in the second posture is loaded on the loading unit 31.

In other words, the liquid container LC2 can be loaded on the loading unit 31 in the first posture in which the ink can be derived from the derivation unit 551 to the liquid ejection apparatus 10. Further, the liquid container LC2 can be loaded in the second posture which is different from the first posture, and in which the ink can be derived from the derivation unit 552 to the liquid ejection apparatus 10. The derivation unit 551 is an example of a first derivation portion, and the derivation unit 552 is an example of a second derivation portion.

Further, the liquid container LC2 includes a substrate unit 562 as the substrate unit 56 in addition to the substrate unit 561 similar to that of the liquid container LC1. The substrate unit 562 is attached to the outer side surface of the side wall that is the back side in the loading direction out of the side walls of the housing 57. The substrate unit 562 is disposed at a position at the −Z direction side of the derivation unit 552 in the Z-axis direction. Accordingly, when the liquid container LC2 is loaded on the loading unit 31 in the second posture, a contact point 562c (not shown) provided to the substrate unit 562 is electrically coupled to the coupling terminal 361.

When the liquid container LC2 is loaded on the loading unit 31 in the first posture, a contact point 561c (not shown) provided to the substrate unit 561 is electrically coupled to the coupling terminal 361 similarly to the liquid container LC1. The contact point 561c is an example of a first contact point, and the contact point 562c is an example of a second contact point.

Then, the liquid container LC4 will be described. As shown in FIG. 4, the liquid container LC4 is provided with the divider 53 that divides the containing unit 541 of the liquid container LC1 into four parts. The divider 53 is provided at the center in the Z-axis direction and the center in the Y-axis direction of the containing unit 54 of the liquid container LC1. The divider 53 is formed by thermally welding the centers of the two resin films that form the containing unit 541 of the liquid container LC1 with a predetermined width over the entire length in the Y-axis direction and the Z-axis direction.

Accordingly, the containing unit 541 of the liquid container LC1 is divided into two in each of the Z-axis direction and the Y-axis direction to thereby form the containing units 541, 542, 543, and 544 of the liquid container LC4. The same ink is contained in the containing units 541, 542, 543, and 544. The containing units 541, 542, 543, and 544 in the liquid container LC4 are disposed so as not to communicate with each other. Thus, the ink contained in the liquid container LC4 does not flow between the containing units 541, 542, 543, and 544.

Furthermore, the liquid container LC4 is provided with derivation units 553 and 554 as the derivation unit 55 in addition to the derivation units 551 and 552 similar to those of the liquid container LC2. The derivation unit 553 is attached to the bag body 52 so that the ink contained in the containing unit 543 can flow out to the outside. The derivation unit 554 is attached to the bag body 52 so that the ink contained in the containing unit 544 can flow out to the outside.

Further, in the liquid container LC4, another fixing portion 57f as a third fixing portion is disposed on an inner side surface of a side wall forming a front side in the loading direction out of the side walls of the housing 57 in the loading direction in which the liquid container 51 is attached and detached. The fixing portion 57f as the third fixing portion is disposed at the same position in the Z-axis direction as the fixing portion 57f to which the derivation unit 551 is fixed. By fixing the derivation unit 553 to the fixing portion 57f as the third fixing portion, the tip of the derivation unit 553 protrudes from the outer side surface of the side wall.

Further, in the liquid container LC4, another fixing portion 57f as a fourth fixing portion is disposed on the inner side surface of the side wall forming the front side in the loading direction out of the side walls of the housing 57 in the loading direction in which the liquid container 51 is attached and detached. The fixing portion 57f as the fourth fixing portion is disposed at the same position in the Z-axis direction as the fixing portion 57f to which the derivation unit 552 is fixed. By fixing the derivation unit 554 to the fixing portion 57f as the fourth fixing portion, the tip of the derivation unit 554 protrudes from the outer side surface of the side wall.

Further, by attaching the sealing body 63 to the tip of the derivation pipe 61 of the derivation unit 553, the inside of the derivation unit 553 and the inside of the containing unit 543 from which the derivation unit 553 can derive the ink are sealed. Further, by attaching the sealing body 63 to the tip of the derivation pipe 61 of the derivation unit 554, the inside of the derivation unit 554 and the inside of the containing unit 544 from which the derivation unit 554 can derive the ink are sealed. In other words, the containing units 541, 542, 543, and 544 are individually sealed.

Note that in the present embodiment, the amount of the ink contained in each of the containing units 541, 542, 543, and 544 of the liquid container LC4 is one-fourth of the amount of the ink contained in the containing unit 541 of the liquid container LC1. Further, the sum of the amounts of the ink contained in the containing units 541, 542, 543, and 544 of the liquid container LC4 is the same as the amount of the ink contained in the containing unit 541 of the liquid container LC1.

The expiration date of the ink contained in the containing unit 541 is counted from the timing when the sealed state of the containing unit 541 is released. Further, the expiration date of the ink contained in the containing unit 542 is counted from the timing when the sealed state of the containing unit 542 is released. Further, the expiration date of the ink contained in the containing unit 543 is counted from the timing when the sealed state of the containing unit 543 is released. Further, the expiration date of the ink contained in the containing unit 544 is counted from the timing when the sealed state of the containing unit 544 is released.

Accordingly, compared to the liquid container LC1 that contains the total amount of the ink contained in the containing units 541, 542, 543, and 544 of the liquid container LC4 in the single containing unit 541, the liquid container LC4 can reduce the amount of the ink that needs to be used within the expiration date of the ink to one-fourth.

Thus, in the liquid container LC4, the amount of the ink that can be used with one liquid container 51 deals with when the amount of the ink used per predetermined period is large, and at the same time, the amount of the ink that needs to be used within the expiration date of the ink can deal with when the amount of the ink used per predetermined period is small better than the liquid container LC2. As a result, the liquid container LC4 can prevent a degradation of usability better than the liquid container LC2 compared to the liquid container LC1 including the single containing unit 541 even when the amount of the ink used per predetermined period varies. Further, since it is possible to deal with users who are different in amount of the ink used without preparing the liquid containers 51 of various specifications different in amount of the ink contained, it becomes possible to reduce the cost of the liquid containers 51.

The derivation unit 553 is disposed at a position at the +Z direction side of the center of the liquid container LC4 in the Z-axis direction. The derivation unit 553 is disposed at the same position as the derivation unit 551 in the Z-axis direction. In this case, the derivation direction of the ink from the derivation unit 551 is the −Y direction as an opposite direction to the +Y direction which is the derivation direction of the ink from the derivation unit 553.

The derivation unit 554 is disposed at a position at the −Z direction side of the center of the liquid container LC4 in the Z-axis direction. The derivation unit 554 is disposed at a position at the −Z direction side of the derivation unit 553. Further, the derivation unit 554 is disposed at the same position as the derivation unit 552 in the Z-axis direction. In this case, the derivation direction of the ink from the derivation unit 553 is the +Y direction which is the same as the +Y direction which is the derivation direction of the ink from the derivation unit 554. Further, the derivation unit 553 and the derivation unit 554 are located at the same position in the Y-axis direction along the derivation direction.

Further, in this case, by fixing the derivation units 551, 552, 553, and 554 to the fixing portions 57f of the housing 57, the containing units 541, 542, 543, and 544 are in the state of being coupled to each other in the liquid container LC4. In other words, the housing 57 is an example of the coupling portion CP that couples the containing units 541, 542, 543, and 544 to each other. Further, the divider 53 may be regarded as an example of the coupling portion CP that couples the containing units 541, 542, 543, and 544 to each other.

For example, a posture obtained by reversing the vertical direction of the liquid container 51 in the second posture, and further reversing the +Y direction side and the −Y direction side of the liquid container 51 to reverse the loading direction is defined as a third posture of the liquid container 51. In other words, the posture obtained by reversing the +Y direction side and the −Y direction side of the liquid container 51 in the first posture shown in FIG. 3 to reverse the loading direction is defined as the third posture. Further, a posture obtained by reversing the +Z direction side and the −Z direction side of the liquid container 51 in the third posture to flip the liquid container 51 is defined as a fourth posture of the liquid container 51.

In this case, the derivation unit 553 is disposed at a position where the derivation unit 553 is coupled to the introduction unit 351 of the liquid supply unit 30 when the liquid container LC4 in the third posture is loaded on the loading unit 31. Further, in this case, the derivation unit 554 is disposed at a position where the derivation unit 554 is coupled to the introduction unit 351 of the liquid supply unit 30 when the liquid container LC4 in the fourth posture is loaded on the loading unit 31.

In other words, the liquid container LC4 can be loaded on the loading unit 31 in the first posture in which the ink can be derived from the derivation unit 551 to the liquid ejection apparatus 10. Further, the liquid container LC4 can be loaded in the second posture different from the first posture in which the ink can be derived from the derivation unit 552 to the liquid ejection apparatus 10. Further, the liquid container LC4 can be loaded in the third posture different from the first posture and the second posture in which the ink can be derived from the derivation unit 553 to the liquid ejection apparatus 10. Further, the liquid container LC4 can be mounted in a fourth posture different from the first posture, the second posture, and the third posture in which ink can be derived from the derivation unit 554 to the liquid ejection apparatus 10. The derivation unit 553 is an example of a third derivation portion, and the derivation unit 554 is an example of a fourth derivation portion.

Further, the liquid container LC4 includes substrate units 563 and 564 as the substrate unit 56 in addition to the substrate units 561 and 562 similar to those of the liquid container LC2. The substrate units 563 and 564 are attached to the outer side surface of the side wall that is the front side in the loading direction out of the side walls of the housing 57. The substrate unit 563 is disposed at the same position as the substrate unit 561 in the Z-axis direction. Accordingly, when the liquid container LC4 is loaded on the loading unit 31 in the third posture, the contact point 563c (not shown) provided on the substrate unit 563 is electrically coupled to the coupling terminal 361. The contact point 563c is an example of a third contact point.

Further, the substrate unit 564 is disposed at the same position as the substrate unit 562 in the Z-axis direction. Accordingly, when the liquid container LC4 is loaded on the loading unit 31 in the fourth posture, the contact point 564c (not shown) provided to the substrate unit 564 is electrically coupled to the coupling terminal 361. The contact point 564c is an example of a fourth contact point.

Note that when the liquid container LC4 is loaded on the loading unit 31 in the first posture, the contact point 561c provided on the substrate unit 561 is electrically coupled to the coupling terminal 361 similarly to the liquid container LC2. Further, when the liquid container LC4 is loaded on the loading unit 31 in the second posture, the contact point 562c provided on the substrate unit 562 is electrically coupled to the coupling terminal 361 similarly to the liquid container LC2.

Here, the container information stored in the container side storage unit provided to the substrate unit 56 will be described. The container information includes information relating to the liquid container 51 and information relating to the containing unit 54 provided to the liquid container 51.

The information relating to the liquid container 51 includes containing unit containing information, manufacturing information, liquid information, liquid amount information, and unique identification information. Information relating to the liquid container 51 is stored in all the substrate units 56 of the liquid container 51.

The containing unit containing information includes the number of containing units 54 provided to the liquid container 51. The manufacturing information includes the date of manufacture of the liquid container 51. The liquid information includes information such as the type and color of the ink contained in the liquid container 51. The liquid amount information includes an initial content amount of the container which is the amount of the ink initially contained in the liquid container 51, and a remaining amount in the container which is the remaining amount of the ink contained in the liquid container 51. The initial content amount of the container is a sum of initial content amounts FV of the respective containing units 54 provided to the liquid container 51 described later. The remaining amount in the container is the sum of the remaining amounts RV in the containing units 54 of the liquid container 51 described later.

When the ink is supplied from the containing unit 54 of the liquid container 51 to the ejection unit 20, the control unit 11 overwrites and updates the remaining amount in the container. The unique identification information is, for example, a unique code attached to each individual in order to identify the liquid containers 51 from each other.

The information relating to the containing unit 54 includes containing unit manufacturing information, containing unit liquid amount information, containing unit loading information, containing unit expiration date information, and containing unit unique identification information. The information relating to the containing unit 54 is stored in at least the substrate unit 56 related to that containing unit 54 out of the substrate units 56 of the liquid container 51.

The containing unit manufacturing information includes the date of manufacture of the containing unit 54. The containing unit liquid amount information includes the initial content amount FV of the containing unit as the amount of the ink initially contained in the containing unit 54, and the remaining amount RV that is the remaining amount of the ink contained in the containing unit 54.

The containing unit loading information is a loading date when the derivation unit 55 provided to the containing unit 54 is coupled to the introduction unit 35 of the loading unit 31 for the first time. In the present embodiment, when the derivation unit 55 provided in the containing unit 54 is coupled to the introduction unit 35 of the loading unit 31, the sealed state of the containing unit 54 and the derivation unit 55 with the sealing body 63 is released. Therefore, the elapsed time from the loading date is the elapsed time from when the sealed state of the containing unit 54 is released.

When the derivation unit 55 provided to the containing unit 54 is first coupled to the introduction unit 35 of the loading unit 31, the control unit 11 writes the loading date to the container side storage unit. Note that the elapsed time after the sealed state of the containing unit 54 is released includes, for example, a period in which the liquid container 51 is detached from the loading unit 31 after the derivation unit 55 is first coupled to the introduction unit 35. For this reason, when the loading date is already written in the container side storage unit as the containing unit loading information, the control unit 11 does not overwrite the loading data in the container side storage unit with a new loading date.

The containing unit expiration date information includes a guaranteed period WP which is a period in which the quality of the ink contained in the containing unit 54 is guaranteed after the sealed state of the containing unit 54 is released. A predetermined time obtained in advance by experiments or the like is applied to the guaranteed period WP. For example, the guaranteed period WP of the containing unit 541 of the liquid containers LC2 and LC4 is set to a guaranteed period WP1, and the guaranteed period WP of the containing unit 542 of the liquid container LC2 is set to a guaranteed period WP2. Further, for example, the guaranteed period WP of the containing unit 543 of the liquid container LC4 is set to a guaranteed period WP3, and the guaranteed period WP of the containing unit 544 of the liquid container LC4 is set to a guaranteed period WP4. In the present embodiment, since the initial content amounts FV of the containing units 541, 542, 543, and 544 are set to be the same as each other, the guaranteed periods WP1, WP2, WP3, and WP4 are also normally set to the same value.

However, for example, it is assumed that a difference in the guaranteed period WP by the time from the manufacture of the containing units 541 and 542 to the release of the sealed state of the containing units 541 and 542 is confirmed by an experiment or the like. In this case, the guaranteed period WP1 and the guaranteed period WP2 are set to values different from each other. In the following description, the guaranteed period WP1 may be referred to as a first predetermined time, and the guaranteed period WP2 may be referred to as a second predetermined time.

The containing unit unique identification information is, for example, a unique code attached to each of the containing units 54 in order to identify the containing units 54 provided to the liquid container 51 from each other.

When the liquid container 51 is loaded on the loading unit 31, the control unit 11 reads the container information from the container side storage unit of the substrate unit 56 electrically coupled to the coupling terminal 36. Then, the control unit 11 stores the container information thus read in the storage unit 13 as the container individual information. The container individual information is stored in an address assigned in advance in the storage unit 13 for each liquid container 51.

Further, it is assumed that there is a history that the liquid container 51 was loaded on the loading unit 31 before the present loading of the liquid container 51 on the loading unit 31. In this case, the container individual information in the storage unit 13 may include container information that is not stored or not updated in the container side storage unit of the substrate unit 56. In this case, when the liquid container 51 is loaded on the loading unit 31, the control unit 11 writes the container information to the container side storage unit of the substrate unit 56. As the container information, liquid amount information in the information relating to the liquid container 51 can be cited. Further, examples of the container information include the containing unit liquid amount information, the containing unit loading information, and the like in the information relating to the containing unit 54 which has the history that the derivation unit 55 has already been coupled to the introduction unit 35 of the loading unit 31.

Then, an outline of control processing executed in the liquid ejection apparatus 10 will be described. The control processing executed in the liquid ejection apparatus 10 includes, for example, a container information processing and a remaining amount confirmation processing. The control unit 11 executes the control processing described above every time the occurrence of an event serving as a trigger is detected.

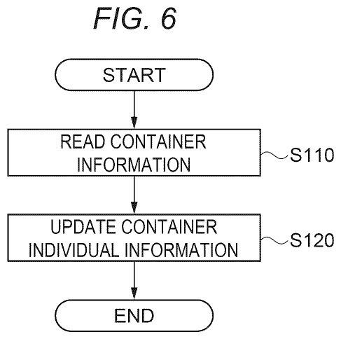

Then, processing executed by the control unit 11 in the container information processing will be described based on the flow shown in FIG. 6. The container information processing is executed when the loading of the liquid container 51 on the loading unit 31 is detected, or when the remaining amount confirmation processing is executed.

In step S110, the control unit 11 executes reading of the container information. The control unit 11 reads the container information stored in the container side storage unit provided to the substrate unit 56 of the liquid container 51 loaded on the loading unit 31. Note that the substrate unit 56 is a substrate unit 56 that is electrically coupled to the coupling terminal 36 of the loading unit 31 out of the substrate units 56 provided to the liquid container 51. When the process in step S110 ends, the control unit 11 makes the transition of the processing to step S120.

In step S120, the control unit 11 executes the update of the container individual information. The control unit 11 stores the container information read in step S110 in the storage unit 13 as the container individual information. By the container information of the liquid container 51 being stored in the storage unit 13 as the container individual information, information relating to the liquid container 51 loaded on the loading unit 31 and information relating to the containing unit 54 provided to the liquid container 51 are also stored.

Accordingly, the information relating to the liquid container 51 loaded on the loading unit 31 included in the container individual information of the liquid container 51 loaded on the loading unit 31, and the information relating to the containing unit 54 provided to the liquid container 51 are updated. Note that the containing unit 54 is the containing unit 54 provided with the derivation unit 55 coupled to the introduction unit 35 of the loading unit 31 out of the containing units 54 provided to the liquid container 51. When the process in step S120 ends, the control unit 11 ends the container information processing.

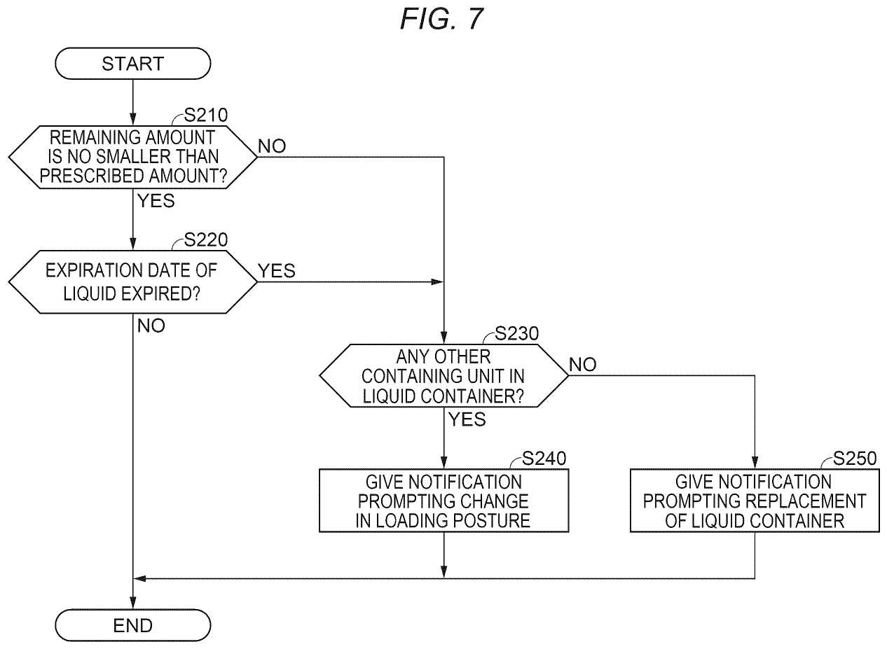

Then, processing executed by the control unit 11 in the remaining amount confirmation processing will be described based on the flow shown in FIG. 7. The remaining amount confirmation processing is executed, for example, when the liquid container 51 is loaded on the loading unit 31 or when a command from the user is received via the operation unit 17. Further, the remaining amount confirmation processing is executed, for example, when print data is input to the control unit 11 through the communication unit 18 or when the ink in the liquid container 51 loaded on the loading unit 31 is consumed by the print processing or the like by the ejection unit 20.

In step S210, the control unit 11 confirms whether the remaining amount RV in the containing unit 54 coupled to the introduction unit 35 of the liquid supply unit 30 is equal to or greater than a prescribed amount in the liquid container 51 loaded on the loading unit 31. The prescribed amount is set to, for example, 1 to 5% of the initial content amount FV of the containing unit 54. Note that the remaining amount RV and the initial content amount FV of the containing unit are stored as either the container individual information of the storage unit 13 or the container information of the container side storage unit in the liquid container 51.

When the remaining amount RV in the containing unit 54 coupled to the introduction unit 35 in the liquid container 51 loaded on the loading unit 31 is equal to or greater than the prescribed amount, YES is determined in step S210. In this case, the control unit 11 makes the transition of the processing to step S220.

When the remaining amount RV in the containing unit 54 coupled to the introduction unit 35 in the liquid container 51 loaded on the loading unit 31 is less than the prescribed amount, NO is determined in step S210. In this case, the control unit 11 makes the transition of the processing to step S230.

In step S220, the control unit 11 confirms whether the ink contained in the containing unit 54 in which it has been checked in step S210 that the remaining amount RV is equal to or greater than the prescribed amount, has expired the expiration date of that ink. In this confirmation, the containing unit loading information stored as either the container individual information in the storage unit 13 or the container information in the container side storage unit in the liquid container 51 and the guaranteed period WP of the containing unit expiration date information are used.

When the ink contained in the containing unit 54 coupled to the introduction unit 35 of the liquid supply unit 30 in the liquid container 51 loaded on the loading unit 31 has not passed the expiration date of the ink, NO is determined in step S220. In this case, the control unit 11 terminates the remaining amount confirmation processing.

When the ink contained in the containing unit 54 coupled to the introduction unit 35 of the liquid supply unit 30 in the liquid container 51 loaded on the loading unit 31 has passed the expiration date of the ink, YES is determined in step S220. In this case, the control unit 11 makes the transition of the processing to step S230.

In step S230, the control unit 11 confirms whether there is another containing unit 54 in the liquid container 51 loaded on the loading unit 31. In this confirmation, the containing unit storage information stored as either the container individual information in the storage unit 13 or the container information in the container side storage unit in the liquid container 51 is used.

When the liquid container 51 loaded on the loading unit 31 includes the containing unit 54 other than the containing unit 54 coupled to the introduction unit 35 of the liquid supply unit 30, YES is determined in step S230. In this case, the control unit 11 makes the transition of the processing to step S240.

When there is no containing unit 54 other than the containing unit 54 coupled to the introduction unit 35 of the liquid supply unit 30 in the liquid container 51 loaded on the loading unit 31, NO is determined in step S230. In this case, the control unit 11 makes the transition of the processing to step S250.

In step S240, the control unit 11 performs notification for prompting a change in the loading posture of the liquid container 51 loaded on the loading unit 31. Specifically, the control unit 11 notifies the user by displaying, on the display unit 15, a message prompting the user to change the loading posture of the liquid container 51 loaded on the loading unit 31. When the process in step S240 ends, the control unit 11 terminates the remaining amount confirmation processing.

In step S250, the control unit 11 gives notification for prompting replacement of the liquid container 51 loaded on the loading unit 31. Specifically, the control unit 11 notifies the user by displaying, on the display unit 15, a message prompting the user to replace the liquid container 51 loaded on the loading unit 31. When the process in step S250 ends, the control unit 11 terminates the remaining amount confirmation processing.

For example, it is assumed that the liquid container LC2 is loaded on the loading unit 31 in the first posture, and the elapsed time from when the contact point 561c of the substrate unit 561 is: initially coupled electrically to the coupling terminal 361 has reached the guaranteed period WP1. In this case, when the remaining amount confirmation processing is executed on the liquid container LC2 loaded on the loading unit 31, the control unit 11 determines that the expiration date of the ink contained in the containing unit 541 has passed.

The liquid container LC2 includes the containing units 541 and 542. Therefore, when it is determined that the expiration date of the ink contained in the containing unit 541 has passed, the control unit 11 gives notification for prompting the change of the loading posture of the liquid container LC2 to the second posture.

When the user loads the liquid container LC2 in the second posture on the loading unit 31 in response to the notification prompting the user to change the loading posture of the liquid container LC2 to the second posture, the contact point 562c of the substrate unit 562 is electrically coupled to the coupling terminal 361.

Then, it is assumed that the liquid container LC2 is loaded on the loading unit 31 in the second posture, and the elapsed time from when the contact point 562c of the substrate unit 562 is initially coupled electrically to the coupling terminal 361 has reached the guaranteed period WP2. In this case, when the remaining amount confirmation processing is executed on the liquid container LC2 loaded on the loading unit 31, the control unit 11 determines that the expiration date of the ink contained in the containing unit 542 has passed.

The liquid container LC2 does not include the containing unit 54 besides the containing units 541 and 542. Therefore, when it is determined that the expiration date of the ink contained in the containing unit 542 has passed, the control unit 11 gives notification for prompting replacement of the liquid container LC2.

Further, for example, it is assumed that the liquid container LC4 is loaded on the loading unit 31 in the first posture, and the elapsed time from when the contact point 561c of the substrate unit 561 is initially coupled electrically to the coupling terminal 361 has reached the guaranteed period WP1. In this case, when the remaining amount confirmation processing is executed on the liquid container LC4 loaded on the loading unit 31, the control unit 11 determines that the expiration date of the ink contained in the containing unit 541 has passed.

The liquid container LC4 includes the containing units 541, 542, 543, and 544. Therefore, when it is determined that the expiration date of the ink contained in the containing unit 541 has passed, the control unit 11 gives notification for prompting the change of the loading posture of the liquid container LC4 to the second posture.

When the user loads the liquid container LC4 in the second posture on the loading unit 31 in response to the notification prompting the user to change the loading posture of the liquid container LC4 to the second posture, the contact point 562c of the substrate unit 562 is electrically coupled to the coupling terminal 361.

Then, it is assumed that the liquid container LC4 is loaded on the loading unit 31 in the second posture, and the elapsed time from when the contact point 562c of the substrate unit 562 is initially coupled electrically to the coupling terminal 361 has reached the guaranteed period WP2. In this case, when the remaining amount confirmation processing is executed on the liquid container LC4 loaded on the loading unit 31, the control unit 11 determines that the expiration date of the ink contained in the containing unit 542 has passed.

The liquid container LC4 includes the containing units 541, 542, 543, and 544. Therefore, when it is determined that the expiration date of the ink contained in the containing unit 542 has passed, the control unit 11 gives notification for prompting the change of the loading posture of the liquid container LC4 to the third posture.

When the user loads the liquid container LC4 in the third posture on the loading unit 31 in response to the notification prompting the user to change the loading posture of the liquid container LC4 to the third posture, the contact point 563c (not shown) of the substrate unit 563 is electrically coupled to the coupling terminal 361.

Then, it is assumed that the liquid container LC4 is loaded on the loading unit 31 in the third posture, and the elapsed time from when the contact point 563c of the substrate unit 563 is initially coupled electrically to the coupling terminal 361 has reached the guaranteed period WP3. In this case, when the remaining amount confirmation processing is executed on the liquid container LC4 loaded on the loading unit 31, the control unit 11 determines that the expiration date of the ink contained in the containing unit 543 has passed.

The liquid container LC4 includes the containing units 541, 542, 543, and 544. Therefore, when it is determined that the expiration date of the ink contained in the containing unit 543 has passed, the control unit 11 gives notification for prompting the change of the loading posture of the liquid container LC4 to the fourth posture.

When the user loads the liquid container LC4 in the fourth posture on the loading unit 31 in response to the notification prompting the user to change the loading posture of the liquid container LC4 to the fourth posture, the contact point 564c (not shown) of the substrate unit 564 is electrically coupled to the coupling terminal 361.

Then, it is assumed that the liquid container LC4 is loaded on the loading unit 31 in the fourth posture, and the elapsed time from when the contact point 564c of the substrate unit 564 is initially coupled electrically to the coupling terminal 361 has reached the guaranteed period WP4. In this case, when the remaining amount confirmation processing is executed on the liquid container LC4 loaded on the loading unit 31, the control unit 11 determines that the expiration date of the ink contained in the containing unit 544 has passed.

The liquid container LC4 does not include the containing unit 54 besides the containing units 541, 542, 543, and 544. Therefore, the liquid container LC4 does not contain the ink the expiration date of which has not elapsed. Therefore, when it is determined that the expiration date of the ink contained in the containing unit 544 has passed, the control unit 11 gives notification for prompting replacement of the liquid container LC4. Note that although the configuration in which the loading posture of the liquid container LC4 is changed in the order of the first posture, the second posture, the third posture, and the fourth posture has been described above, the order is not limited thereto. Further, in one or more loading postures, the change of the loading posture may be prompted on the grounds that the remaining amount of the ink is less than the prescribed amount despite the expiration date of the ink has not elapsed.

Note that in step S240, it is assumed that, after the notification for prompting the change of the loading posture of the liquid container 51 loaded on the loading unit 31 is given, the loading of the liquid container 51 the loading posture of which has been changed on the loading unit 31 is not detected. In this case, the control unit 11 is not required to execute the print processing. Alternatively, in this case, the control unit 11 may execute the print processing only when the print data is input through the communication unit 18 or the like and the remaining amount RV in the containing unit 54 coupled to the introduction unit 35 is equal to or greater than the prescribed amount.

As described above, according to the liquid containers 51 including the liquid containers LC2 and LC4 and the liquid ejection apparatus 10 related to Embodiment 1, the following advantages can be obtained.

The liquid container 51 can contain the ink to be ejected onto the medium P by the liquid ejection apparatus 10. The liquid container 51 includes the containing unit 541 that contains ink, and the containing unit 542 that is disposed not to communicate with the containing unit 541 and contains the same ink as the ink contained in the containing unit 541. Further, the liquid container 51 includes the coupling portion CP that couples the containing unit 541 and the containing unit 542 to each other. Further, the containing unit 541 is provided with the derivation unit 551 capable of deriving the ink contained in the containing unit 541, and the containing unit 542 is provided with the derivation unit 552 capable of deriving the ink contained in the containing unit 542. The containing unit 541 and the containing unit 542 are individually sealed.

According to this, the expiration date of the ink contained in the containing unit 541 is counted from the timing when the sealing of the containing unit 541 is released. Further, the expiration date of the ink contained in the containing unit 542 is counted from the timing when the sealing of the containing unit 542 is released. Accordingly, it is possible to reduce the amount of the ink that needs to be used within the expiration date of the ink, compared to the liquid container 51 that contains the total amount of the ink contained in the containing unit 541 and the containing unit 542 in the single containing unit 54. Thus, in the liquid container 51, the amount of the ink that can be used with one liquid container 51 deals with when the amount of the ink used per predetermined period is large, and at the same time, the amount of the ink that needs to be used within the expiration date of the ink can deal with when the amount of the ink used per predetermined period is small. As a result, even when the amount of the ink used per predetermined period varies, deterioration in usability can be prevented. Further, since it is possible to deal with users who are different in amount of the ink used without preparing the liquid containers 51 of various specifications different in amount of the ink contained, it becomes possible to reduce the cost of the liquid containers 51.

The derivation direction of the ink from the derivation unit 551 is the same as the derivation direction of the ink from the derivation unit 552. According to this, the operation of changing the derivation unit 55 that derives the ink to any other derivation units 55 in order to change the ink to be ejected by the liquid ejection apparatus 10 to the ink contained in any other containing units 54 becomes easy.

The derivation unit 551 and the derivation unit 552 are located at the same position in the direction along the derivation direction. According to this, the configuration of the liquid ejection apparatus 10 for changing the derivation unit 55 that derives the ink to any other derivation units 55 is easy to design.

The coupling portion CP is the housing 57 that houses the containing unit 541 and the containing unit 542. According to this, since the liquid container 51 can be configured by housing the plurality of containing units 54 in the housing 57, the liquid container 51 can easily be manufactured. Further, it is easy for the user to recognize the liquid container 51 as a single liquid container 51.

The liquid container 51 is detachably attached to the loading unit 31 of the liquid ejection apparatus 10. According to this, usability can be improved for a user who uses the liquid ejection apparatus 10 having the configuration in which the liquid container 51 is detachably replaced.

The liquid container 51 can be loaded on the loading unit 31 in the first posture in which the ink can be derived from the derivation unit 551 to the liquid ejection apparatus 10. Further, the liquid container 51 can be loaded on the loading unit 31 in the second posture which is different from the first posture, and in which the ink can be derived from the derivation unit 552 to the liquid ejection apparatus 10. According to this, the loading posture of the liquid container 51 is changed by the operation of changing the derivation unit 55 that derives the ink to any other derivation units 55. Thus, the ink in the containing unit 54 is stirred. Therefore, sedimentation in the solvent component of the ink such as a pigment component contained in the ink is apt to be prevented.

The liquid container 51 has the contact point 561c that can electrically be coupled to the coupling terminal 36 of the loading unit 31 when the liquid container 51 is loaded on the loading unit 31 in the first posture. Further, the liquid container 51 has the contact point 562c that can electrically be coupled to the coupling terminal 36 when the liquid container 51 is loaded on the loading unit 31 in the second posture. According to this, it is possible to handle information relating to the containing unit 54 for each of the containing units 54. Further, the loading posture of the liquid container 51 can be determined based on which of the plurality of contact points 56c is electrically coupled to the coupling terminal 36.

The liquid ejection apparatus 10 includes the loading unit 31 to which the liquid container 51 can detachably be attached, the coupling terminal 36 provided to the loading unit 31, and the control unit 11. The liquid container 51 can be loaded on the loading unit 31 in the first posture in which the ink can be derived from the derivation unit 551 as an example of the first derivation unit to the liquid ejection apparatus 10. Further, the liquid container 51 can be loaded on the loading unit 31 in the second posture which is different from the first posture, and in which the ink can be derived from the derivation unit 552 as an example of the second derivation unit to the liquid ejection apparatus 10. Further, the liquid container 51 has the contact point 561c that can electrically be coupled to the coupling terminal 36 when the liquid container 51 is loaded on the loading unit 31 in the first posture. Further, the liquid container 51 has the contact point 562c that can electrically be coupled to the coupling terminal 36 when the liquid container 51 is loaded on the loading unit 31 in the second posture. Then, when the elapsed time from when the contact point 561c and the coupling terminal 36 are electrically coupled to each other has reached the guaranteed period WP1, the control unit 11 determines that the expiration date of the ink contained in the containing unit 541 has passed. Further, when the elapsed time after the contact point 562c and the coupling terminal 36 are electrically coupled has reached the guaranteed period WP2, the control unit 11 determines that the expiration date of the ink contained in the containing unit 542 has passed.

According to this, by regarding the timing at which the contact point 56c and the coupling terminal 36 are electrically coupled to each other for the first time as the timing at which the sealed state of the containing unit 54 is released, the expiration date of the ink in the containing unit 54 can be managed.

When the control unit 11 determines that the expiration date of the ink contained in the containing unit 541 has passed, the control unit 11 gives notification for prompting the change to the second posture. According to this, by prompting the change of the loading posture of the liquid container 51, it is possible to prevent the ink that expires the expiration date from being supplied to the liquid ejection apparatus 10.

When the expiration date of the ink contained in the containing unit 541 has passed and the expiration date of the ink contained in the containing unit 542 has also passed, the control unit 11 gives notification for prompting replacement of the liquid container 51. According to this, by prompting the replacement of the liquid container 51, it is possible to prevent the ink the expiration date of which has elapsed from being supplied to the liquid ejection apparatus 10.

The liquid container 51 according to the embodiment described above of the present disclosure basically has the configuration as described above, but it is obviously possible to make modifications, omissions, and so on of a partial configuration without departing from the gist of the present disclosure. Further, the liquid ejection apparatus 10 according to the embodiment described above of the present disclosure e basically has the configuration as described above, but it is obviously possible to make modifications, omissions, and so on of a partial configuration without departing from the gist of the present disclosure. Further, the embodiment described above and other embodiments described below may be combined with each other as long as no technical inconsistencies are involved. Hereinafter, other embodiments will be described.

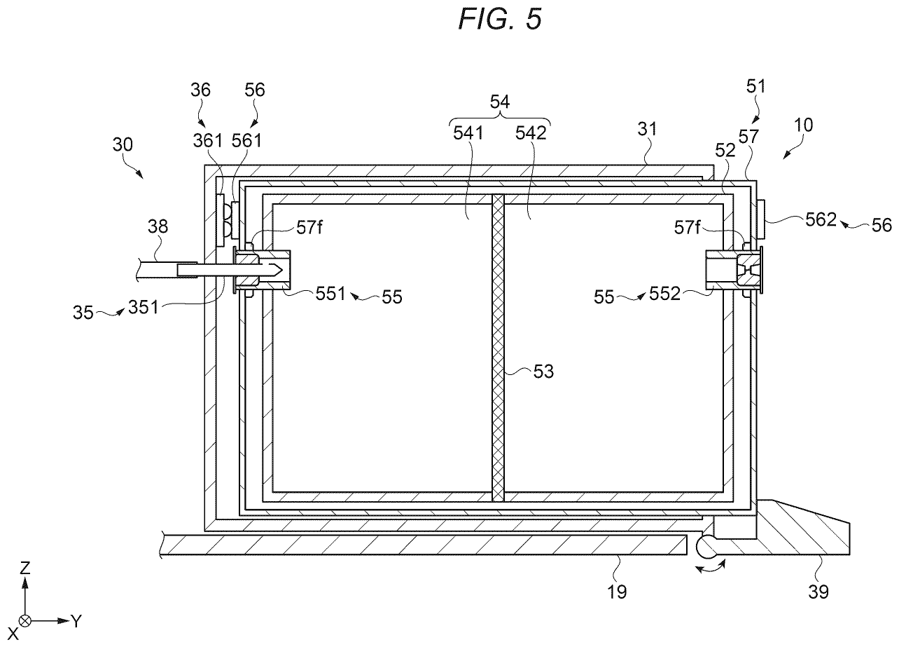

In the embodiment described above, the containing units 541 and 542 of the liquid container LC2 are not required to be formed by dividing the containing unit 541 of the liquid container LC1 by the divider 53 at the center in the Z-axis direction. For example, as shown in FIG. 5, the containing units 541 and 542 of the liquid container LC2 may be formed by dividing the containing unit 541 of the liquid container LC1 by the divider 53 at the center in the Y-axis direction.

In this case, the fixing portion 57f as the second fixing portion of the liquid container LC2 is disposed at the same position as the fixing portion 57f as the third fixing portion (see FIG. 4) of the liquid container LC4. Further, the derivation unit 552 of the liquid container LC2 is disposed at the same position as the derivation unit 553 (see FIG. 4) of the liquid container LC4. Further, in this case, the derivation unit 552 of the liquid container LC2 is disposed at the same position as the derivation unit 551 in the Z-axis direction. Further, in this case, the substrate unit 562 of the liquid container LC2 is disposed at the same position as the substrate unit 563 (see FIG. 4) of the liquid container LC4. Accordingly, in this case, when the liquid container LC2 is loaded on the loading unit 31 in the third posture, the contact point 562c provided to the substrate unit 562 is electrically coupled to the coupling terminal 361.

Alternatively, in this case, the fixing portion 57f as the second fixing portion of the liquid container LC2 may be disposed at the same position as the fixing portion 57f as the fourth fixing portion (see FIG. 4) of the liquid container LC4, unlike the position shown in FIG. 5. Further, the derivation unit 552 of the liquid container LC2 may be disposed at the same position as the derivation unit 554 (see FIG. 4) of the liquid container LC4. Further, in this case, the derivation unit 552 of the liquid container LC2 is disposed at a position different from the position of the derivation unit 551 in the Z-axis direction. Further, in this case, the substrate unit 562 of the liquid container LC2 is disposed at the same position as the substrate unit 564 (see FIG. 4) of the liquid container LC4. Accordingly, in this case, when the liquid container LC2 is loaded on the loading unit 31 in the fourth posture, the contact point 562c provided to the substrate unit 562 is electrically coupled to the coupling terminal 361.

In these cases, in the liquid container 51, the derivation direction of the ink from the derivation unit 551 is opposite to the derivation direction of the ink from the derivation unit 552. According to this, the ink in the containing unit 54 is stirred by the operation of changing the derivation unit 55 that derives the ink to any other derivation units 55. Therefore, sedimentation in the solvent component of the ink such as a pigment component contained in the ink is apt to be prevented.

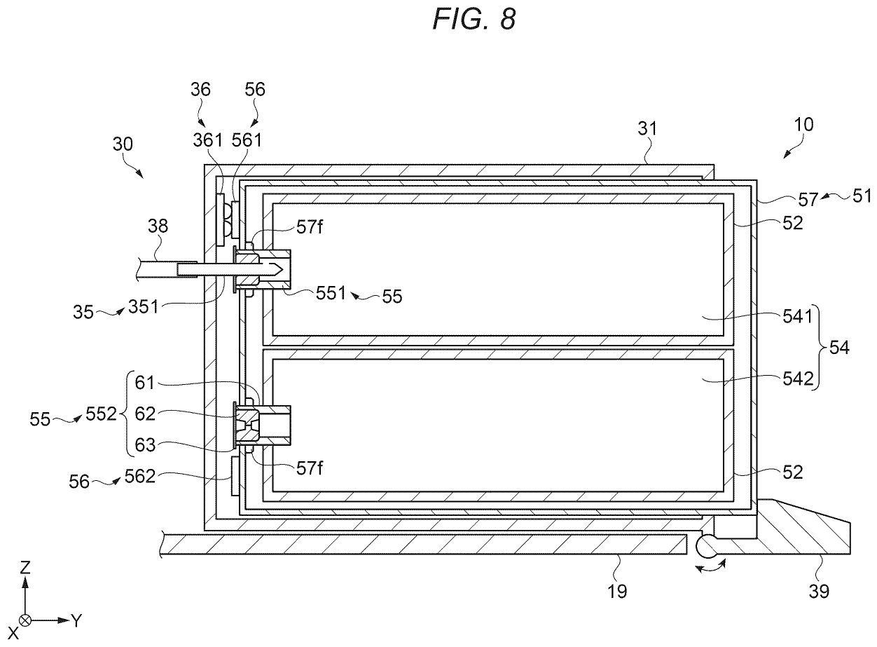

In the embodiment described above, the containing units 541 and 542 of the liquid container LC2 are not required to be formed by dividing the containing unit 541 of the liquid container LC1 by the divider 53. For example, as shown in FIG. 8, the liquid container LC2 may include the containing units 541 and 542 by housing the two bag bodies 52 in the housing 57. In this case, the containing unit 54 corresponding to the bag body 52 which is one of the bag bodies 52, and to which the derivation unit 551 fixed to the fixing portion 57f as the first fixing portion is attached is the containing unit 541. Further, the containing unit 54 corresponding to the bag body 52 which is the other of the bag bodies 52, and to which the derivation unit 552 fixed to the fixing portion 57f as the second fixing portion is attached is the containing unit 542. Further, in this case, since the derivation unit 551 and the derivation unit 552 are fixed to the fixing portions 57f of the housing 57, the containing units 541 and 542 as the two bag bodies 52 are in a state of being coupled to each other by the housing 57 in the liquid container LC2. Further, in this case, the amount of the ink contained in each of the containing units 541 and 542 as the two bag bodies 52 housed in the liquid container LC2 is set to half the amount of the ink contained in the containing unit 541 of the liquid container LC1.

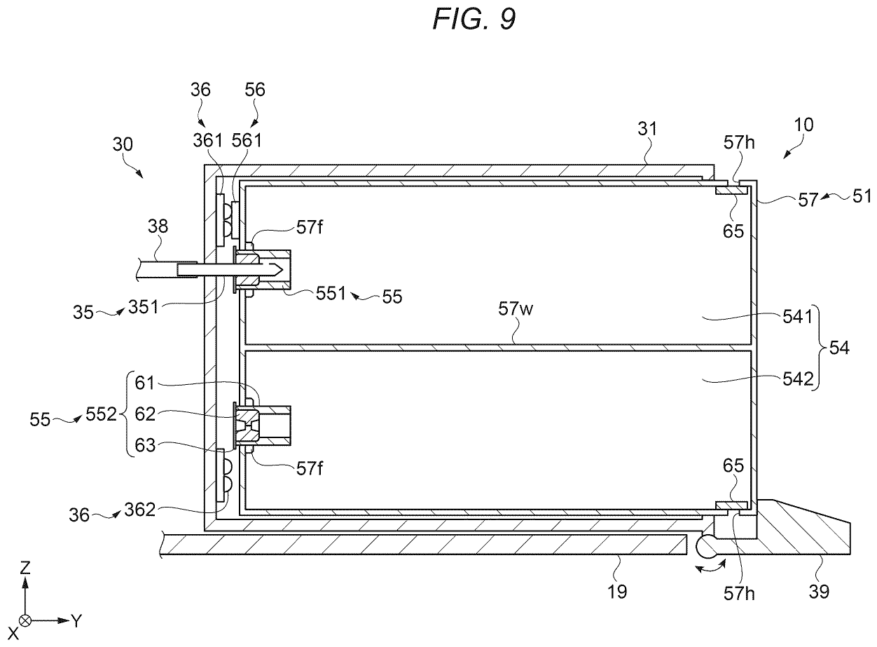

In the embodiment described above, the liquid ejection apparatus 10 may include a plurality of coupling terminals 36 in the loading unit 31 of the liquid supply unit 30. For example, it is assumed that the liquid container 51 loaded on the loading unit 31 is the liquid container LC2 according to Embodiment 1. In this case, a coupling terminal 362 is disposed at a position where the coupling terminal 362 is electrically coupled to the substrate unit 561 of the liquid container LC2 loaded on the loading unit 31 in the second posture. Further, in this case, as shown in FIG. 9, the liquid container LC2 is not required to include the substrate unit 562. In this case, the container side storage unit of the substrate unit 561 may store the information relating to the containing unit 542 in addition to the information relating to the liquid container LC2 and the containing unit 541 as the container information. Further, in this case, the control unit 11 may determine the loading posture of the liquid container LC2 based on which of the coupling terminals 361 and 362 the substrate unit 561 of the liquid container LC2 is electrically coupled to.

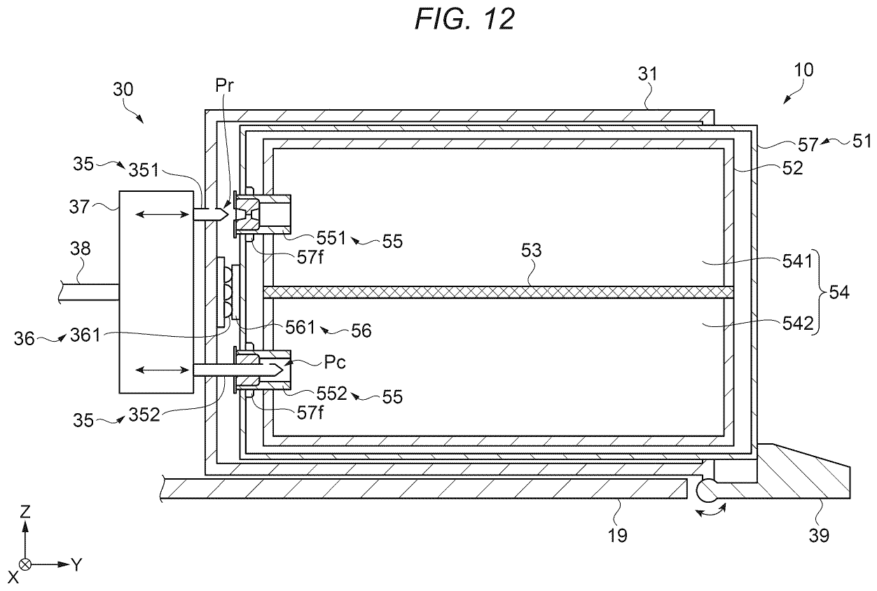

Further, when the liquid container LC2 does not include the substrate unit 562, the substrate unit 561 may be disposed at a position where the substrate unit 561 can electrically be coupled to the coupling terminal 361 in the first posture and the second posture. For example, in this case, as shown in FIG. 12, the substrate unit 561 is disposed at a position corresponding to the center in the Z-axis direction on the side wall forming the back side in the loading direction out of the side walls of the housing 57. Further, the coupling terminal 361 is disposed at a corresponding to the center in the Z-axis direction of the loading unit 31 so that the coupling terminal 361 can electrically be coupled to the substrate unit 561.

In the embodiment described above, the liquid container 51 is not required to include the bag body 52. In this case, in the liquid container 51, the internal space of the housing 57 may be used as the containing unit 54 in which the ink is contained. For example, as shown in FIG. 9, it is assumed that the liquid container 51 is the liquid container LC2. In this case, the housing 57 is provided with a dividing wall 57w that divides the internal space of the housing 57 into two at the center in the Z-axis direction. The dividing wall 57w is formed integrally with other side walls forming the housing 57. The dividing wall 57w extends in the Y-axis direction and connects the side wall at the back side in the loading direction and the side wall at the front side out of the side walls of the housing 57. As a result, the internal space of the housing 57 is divided into two in the Z-axis direction to thereby form the containing units 541 and 542 of the liquid container LC2.

Further, in this case, the derivation pipes 61 of the derivation units 551 and 552 may integrally be formed with the side wall and the fixing portion 57f which constitute the housing 57. Further, when the through hole 57h for opening the containing units 541 and 542 to the atmosphere is provided in the side wall of the housing 57, a gas-liquid separation membrane 65 may be disposed at a position where to cover the opening of the through hole 57h.

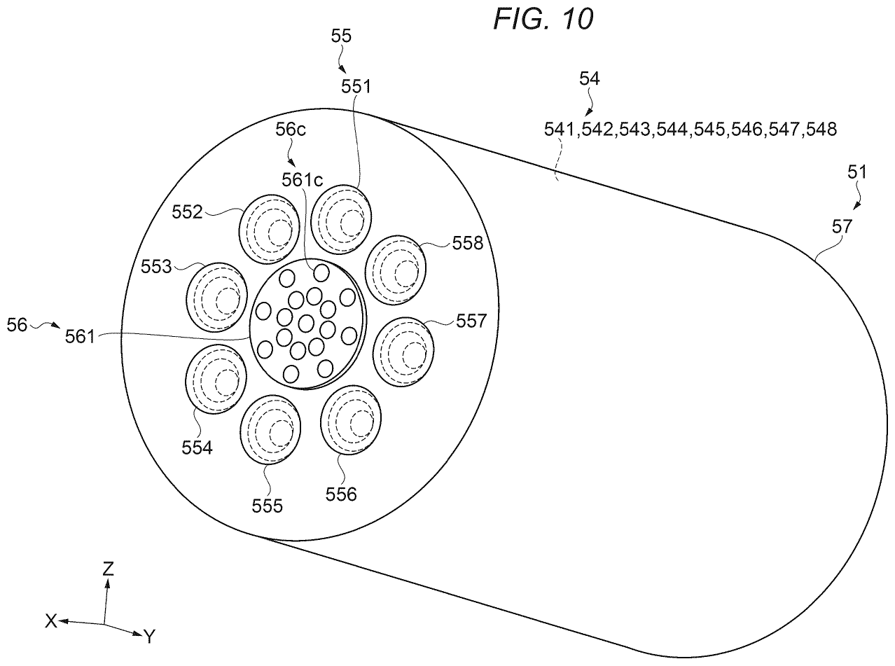

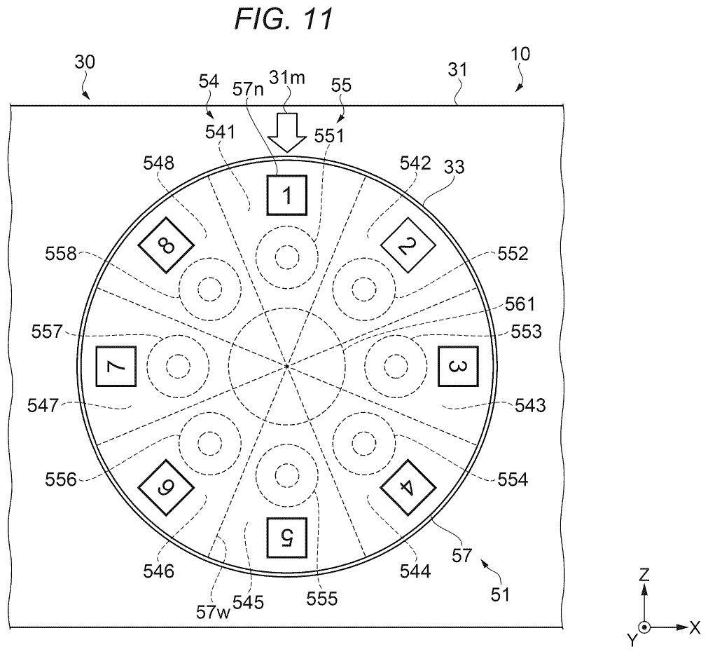

Further, in this case, as shown in FIGS. 10 and 11, the housing 57 of the liquid container 51 may have a cylindrical shape. According to this, it is easy to form the plurality of containing units 54 by dividing the internal space of the housing 57 with the dividing wall 57w. For example, the housing 57 is provided with a dividing wall 57w (see FIG. 11) that radially divides the internal space of the housing 57 into eight parts around the central axis of the cylindrical shape. The dividing wall 57w is formed integrally with other side walls forming the housing 57. The dividing wall 57w extends in the Y-axis direction and connects the side wall at the back side in the loading direction and the side wall at the front side out of the side walls of the housing 57. In this way, eight containing units 541 to 548 of the liquid container 51 are formed.

Further, in this case, eight derivation units 551 to 558 for deriving the ink contained in the respective containing units 541 to 548 to the outside are radially arranged on the side wall forming the back side in the loading direction out of the side walls of the housing 57. Further, in this case, the substrate unit 561 as the substrate unit 56 may be disposed at the center of the side wall forming the back side in the loading direction out of the side walls of the housing 57. The substrate unit 561 is provided with a plurality of contact points 561c as the contact points 56c. The plurality of contact points 561c may include eight contact points 561c disposed corresponding to the positions of the derivation units 551 to 558. Further, the control unit 11 may determine the loading posture of the liquid container LC2 depending on whether any one of the eight contact points 561c is electrically coupled to the coupling terminal 361 (not shown) of the loading unit 31.

Further, in this case, as shown in FIG. 11, eight containing unit numbers 57n to be arranged so as to correspond to the positions of the derivation units 551 to 558 may be indicated on the side wall at the front side in the loading direction out of the side walls of the housing 57. For example, it is assumed that the liquid container 51 is loaded on the loading unit 31 in the first posture in which the derivation unit 551 and the introduction unit 351 are coupled to each other. In this case, the derivation unit 551 and the introduction unit 351 are coupled by loading the liquid container 51 on the loading unit 31 in a state in which “1” out of the containing unit numbers 57n is aligned with a position of a mark 31m.

In the embodiment described above, the liquid supply unit 30 may include an introduction unit 352 as the introduction unit 35 in addition to the introduction unit 351. In this case, the introduction unit 351 is an example of a first introduction unit, and the introduction unit 352 is an example of a second introduction unit. Further, the liquid supply unit 30 may include a coupling switching mechanism 37. For example, as shown in FIG. 12, the introduction unit 352 is disposed at a position where the introduction unit 352 can be coupled to the derivation unit 552 of the liquid container LC2 loaded on the loading unit 31 in the first posture. The coupling switching mechanism 37 supports the introduction units 351 and 352 so as to be movable in a direction along the Y-axis direction indicated by arrows in FIG. 12. Accordingly, the introduction units 351 and 352 move to a coupled position Pc where the introduction units 351 and 352 are coupled to the derivation unit 55 and a separated position Pr where the introduction units 351 and 352 are separated from the derivation unit 55.

When the liquid container 51 is not loaded on the loading unit 31, the control unit 11 controls the coupling switching mechanism 37 to locate the introduction units 351 and 352 at the separated position Pr. Further, the coupling switching mechanism 37 brings the introduction unit which is one of the introduction units 351 and 352, and which is located at the coupled position Pc and the pipe 38 into a communicated state, and brings the introduction unit which is one of the introduction units 351 and 352, and which is located at the separated position Pr and the pipe 38 into a non-communicated state.

For example, when the ink can be derived from the derivation unit 552 of the liquid container LC2 loaded on the loading unit 31, the control unit 11 checks the loading posture of the liquid container LC2 from a coupling state between the substrate unit 561 and the coupling terminal 361. When the loading posture of the liquid container LC2 is the first posture shown in FIG. 12, the control unit 11 controls the coupling switching mechanism 37 to move the introduction unit 352 to the coupled position Pc to bring the introduction unit 352 and the pipe 38 into the communicated state. Accordingly, the ink in the containing unit 542 can be supplied to the head 21 of the ejection unit 20 through the derivation unit 552, the introduction unit 352, and the pipe 38.

In other words, the liquid ejection apparatus 10 includes the loading unit 31 to which the liquid container 51 can be detachably attached, and includes the introduction unit 351 capable of introducing the ink from the derivation unit 551 in the state where the liquid container 51 is loaded in the first posture on the loading unit 31. Further, the liquid ejection apparatus 10 includes the introduction unit 352 capable of introducing the ink from the derivation unit 552 in the state where the liquid container 51 is loaded in the first posture on the loading unit 31. According to this, a frequency of the operation of changing the loading posture of the liquid container 51 in order to change the ink to be ejected by the liquid ejection apparatus 10 to the ink contained in any other containing units 54 can be reduced.

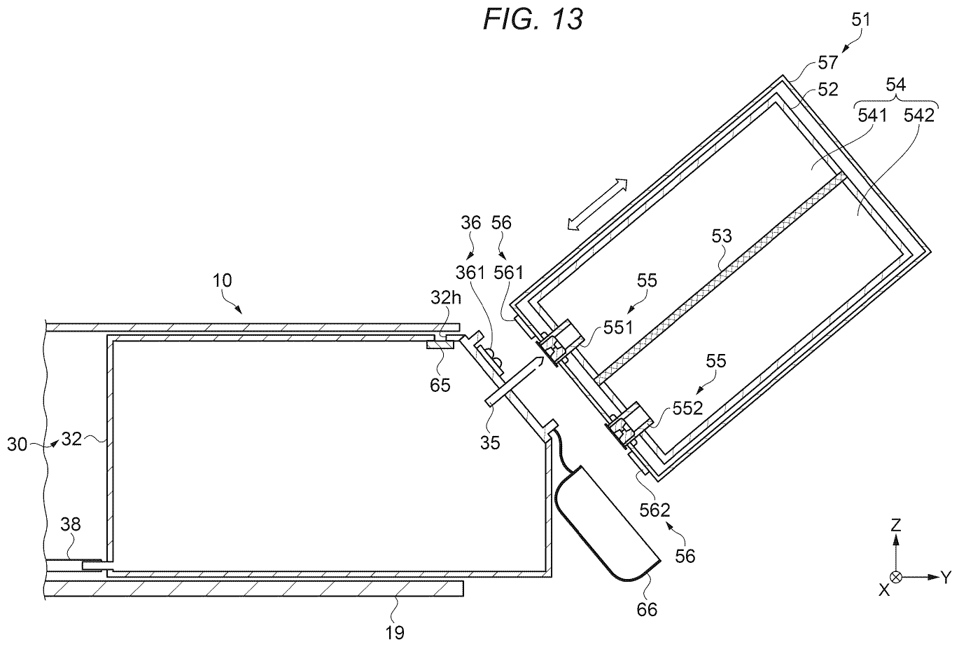

In the embodiment described above, the liquid supply unit 30 is not required to include the loading unit 31. In this case, the liquid supply unit 30 may include a liquid reservoir unit 32 capable of reserving the ink to be ejected to the medium P by the ejection unit 20 of the liquid ejection apparatus 10. For example, as shown in FIG. 13, the liquid reservoir unit 32 is coupled to the pipe 38. In this case, the introduction unit 35 and the coupling terminal 361 in Embodiment 1 are disposed on the side wall of the liquid reservoir unit 32 that is exposed in the +Y direction from the chassis 19 of the liquid ejection apparatus 10. Further, in this case, a cap 66 capable of covering the introduction unit 35 and the coupling terminal 361 may be provided to the liquid reservoir unit 32. Further, when the through hole 32h for opening the liquid reservoir unit 32 to the atmosphere is provided to the side wall of the liquid reservoir unit 32, the gas-liquid separation membrane 65 may be disposed at a position where to cover the opening of the through hole 32h.

Further, when replenishing the liquid reservoir unit 32 with the ink, the user may inject the ink contained by the liquid container LC2 in the containing unit 54 into the liquid reservoir unit 32. In this case, the user detaches the cap 66 and moves the liquid container LC2 along the direction indicated by the unfilled arrows. Then, the user couples the introduction unit 35 and the derivation unit 551 to each other. Thus, the ink contained in the containing unit 541 is injected into the liquid reservoir unit 32. In other words, the liquid container 51 contains the ink to be injected into the liquid reservoir unit 32 provided to the liquid ejection apparatus 10. According to this, it is possible to improve usability for the user who uses the liquid ejection apparatus 10 configured to replenish the liquid reservoir unit 32 with the ink.

Note that when the introduction unit 35 and the derivation unit 551 are coupled to each other, the coupling terminal 361 and the substrate unit 561 are electrically coupled to each other. Thus, the control unit 11 detects the coupling of the derivation unit 551 of the liquid container LC2 to the introduction unit 35 of the liquid reservoir unit 32. When the injection of the ink into the liquid reservoir unit 32 is completed, the user moves the liquid container LC2 along the direction indicated by the unfilled arrows, and detaches the derivation unit 551 from the introduction unit 35. Thus, the electrical coupling between the coupling terminal 361 and the substrate unit 561 is released. Accordingly, the control unit 11 detects that the coupling between the introduction unit 35 and the derivation unit 551 is released.

In the embodiment described above, when the liquid container 51 includes a plurality of the substrate units 56, the substrate units 56 may electrically be coupled to each other with wiring or the like. In this case, the liquid container 51 may include the container side storage unit in any one of the plurality of substrate units 56. Alternatively, the liquid container 51 may include a storage unit substrate (not shown) provided with the container side storage unit, and the storage unit substrate may electrically be coupled to the plurality of substrate units 56 provided to the liquid container 51.

In the embodiment described above, the liquid container LC2 may include a tray capable of holding the bag body 52, instead of the housing 57. In this case, in the loading direction of the liquid container LC2, the fixing portion 57f is disposed on an inner side surface of a side wall forming the back side in the loading direction out of side walls of the tray. Further, in this case, by fixing the derivation unit 551 and the derivation unit 552 to the fixing portions 57f of the tray, the containing unit 541 and the containing unit 542 are in a coupled state in the liquid container LC2. In other words, the tray is an example of the coupling portion CP that couples the containing unit 541 and the containing unit 542 to each other.

In the remaining amount confirmation processing of the embodiment described above, when the expiration date of the ink in the containing unit 54 coupled to the introduction unit 35 has passed, the control unit 11 is not required to give the notification to prompt the change of the loading posture of the liquid container 51. For example, in this case, the control unit 11 may give notification that expiration date of the ink in the containing unit 54 coupled to the introduction unit 35 has passed. Alternatively, in this case, the control unit 11 may give notification that the ink in the containing unit 54 coupled to the introduction unit 35 cannot be used. Note that the control unit 11 may execute the print processing only when there is an instruction of the print processing from the operation unit 17 or the like despite these notifications, and the remaining amount RV in the containing unit 54 coupled to the introduction unit 35 is equal to or greater than the prescribed amount.

The liquid containers LC2 and LC4 are not required to include the substrate unit 56. For example, the liquid containers LC2 and LC4 may include a metal member that is electrically coupled to the coupling terminal 36 of the liquid ejection apparatus 10 when the derivation unit 55 is coupled to the introduction unit 35. In this case, the metal member electrically coupled to the coupling terminal 36 when the derivation unit 551 is coupled to the introduction unit 35 is an example of the first contact point. Further, in this case, the metal member electrically coupled to the coupling terminal 36 when the derivation unit 552 is coupled to the introduction unit 35 is an example of the second contact point. Further, in this case, the liquid container 51 is not required to include the container side storage unit. Then, it is assumed that, for example, in the remaining amount confirmation processing, the control unit 11 gives the notification to prompt the change of the loading posture of the liquid container 51. In this case, the control unit 11 may give the notification to prompt the change of the loading posture of the liquid container 51 to the loading posture in which the derivation unit 55 having no loading history is coupled to the introduction unit 35. In this notification, the control unit 11 may give a notification that the loading history of the derivation unit 55 is known by checking the state of the sealing body 63 of the derivation unit 55.

What is claimed is:

1. A liquid container configured to contain a liquid to be ejected onto a medium by a liquid ejection apparatus, the liquid container comprising:
a first containing unit configured to contain the liquid;
a second containing unit which is disposed not to communicate with the first containing unit, and which is configured to contain a same liquid as the liquid contained in the first containing unit; and
a coupling portion configured to couple the first containing unit and the second containing unit to each other, wherein
the first containing unit is provided with a first derivation unit configured to derive the liquid contained in the first containing unit,
the second containing unit is provided with a second derivation unit configured to derive the liquid contained in the second containing unit, and
the first containing unit and the second containing unit are individually sealed.

2. The liquid container according to claim 1, wherein
a derivation direction of the liquid from the first derivation unit is same as a derivation direction of the liquid from the second derivation unit.

3. The liquid container according to claim 2, wherein
the first derivation unit and the second derivation unit are located at a same position in a direction along the derivation direction.

4. The liquid container according to claim 1, wherein
a derivation direction of the liquid from the first derivation unit is opposite to a derivation direction of the liquid from the second derivation unit.

5. The liquid container according to claim 1, wherein
the coupling portion is a housing configured to house the first containing unit and the second containing unit.

6. The liquid container according to claim 1, wherein
the liquid container contains the liquid to be injected into a liquid reservoir unit provided to the liquid ejection apparatus.

7. The liquid container according to claim 1, wherein
the liquid container is detachably attached to a loading unit of the liquid ejection apparatus.

8. The liquid container according to claim 7, wherein
the liquid container is configured to be loaded on the loading unit in
a first posture in which the liquid is derived from the first derivation unit to the liquid ejection apparatus, and
a second posture which is different from the first posture, and in which the liquid is derived from the second derivation unit to the liquid ejection apparatus.

9. The liquid container according to claim 8, further comprising:
a first contact point configured to electrically be coupled to a coupling terminal of the loading unit when the liquid container is loaded on the loading unit in the first posture; and
a second contact point configured to electrically be coupled to the coupling terminal when the liquid container is loaded on the loading unit in the second posture.

10. A liquid ejection apparatus comprising:
the loading unit on which the liquid container according to claim 9 is detachably loaded;
the coupling terminal provided to the loading unit; and
a control unit, wherein
the control unit is configured to
determine that an expiration date of the liquid contained in the first containing unit passed when an elapsed time from when the first contact point and the coupling terminal are electrically coupled to each other reached a first predetermined time, and
determine that the expiration date of the liquid contained in the second containing unit passed when an elapsed time from when the second contact point and the coupling terminal are electrically coupled to each other reached a second predetermined time.

11. The liquid ejection apparatus according to claim 10, wherein
when expiration of the expiration date of the liquid contained in the first containing unit is determined, the control unit gives a notification of prompting a change to the second posture.

12. The liquid ejection apparatus according to claim 11, wherein
when the expiration date of the liquid contained in the first containing unit expired, and the expiration date of the liquid contained in the second containing unit expired, the control unit gives a notification of prompting replacement of the liquid container.

13. A liquid ejection apparatus comprising:
the loading unit configured to detachably load the liquid container according to claim 1;
a first introduction unit configured to introduce the liquid from the first derivation unit in a state where the liquid container is loaded on the loading unit in a first posture; and
a second introduction unit configured to introduce the liquid from the second derivation unit in a state where the liquid container is loaded on the loading unit in the first posture.
